(19) United States
(12) Patent Application Publication
(10) Pub. No.: US 2009/0288351 A1
(43) Pub. Date: Nov. 26, 2009

(54) FOLDING LOFT STAIR ASSEMBLY

(76) Inventor: Michael Burke, County Galway (IE)

Correspondence Address: THE LAW OFFICES OF JOHN CHUPA & ASSOCIATES, P.C., 28535 ORCHARD LAKE ROAD, SUITE 50, FARMINGTON HILLS, MI, 48334, US

(21) Appl. No.: 11/914,717

(22) PCT Filed: May 18, 2006
(86) PCT No.: PCT/EP2006/062429

§ 371 Date: Mar. 11, 2008

(30) Foreign Application Priority Data
May 18, 2005 (IE) S2005/0327

(51) Int. Cl. E04F 11/06; G05G 11/00

(52) U.S. Cl. 52/183; 74/490.07

(57) ABSTRACT

A folding loft stair assembly (1) has an outer mounting frame (2) for mounting in a ceiling ope giving access to an attic space in a building. An inner stairway support frame (3) is pivotally mounted on the outer frame (2) for movement between a nested position within the outer frame (2) and a downwardly extending In-use position, A two-art collapsible stairway (4) is movable on the inner frame (3) by a remotely controlled actuator (5) between a raised collapsed stored position and lowered in-use position. The stairway (4) Includes an upper part (30) and a lower part (31 ) hingedly connected (38) to the upper part (30). An upper end of the upper part (30) Is hingedly mounted on the inner frame (3). The lower part (31) is slidably connected to the inner frame (3) by a pair of slide arms (40). An inner end of each slide arm (40) is pivotally connected to the inner frame (3) and an outer end of the slide arm (40) slidably engages a slide rail (42) on the lower part (31)

### BACKGROUND OF THE INVENTION

1. Field of the Invention

This invention relates to a folding loft stair assembly for providing access to an attic space in a building for example.

2. Discussion of Prior Art

Various types of folding attic or loft stair are well known. Essentially a collapsible stair assembly is stored in the attic at an access opening in a ceiling for example. When required for use a person manually pulls down and extends the stair to provide access to the attic. However, in some cases elderly or infirm people have difficulty in manually extending and folding the stairs. Also, with relatively high ceilings, say over about three metres high, reaching the folded stair to pull the stair outwardly and downwardly from the ceiling ope to deploy the stair can present a problem.

The present invention is directed towards overcoming these problems.

### SUMMARY OF THE INVENTION

According to the invention there is provided a folding loft stair assembly, including:
an outer mounting frame for fixing in an associated ceiling ope,
an inner stairway support frame pivotally mounted on the outer frame for movement between a nested position within the outer frame and a downwardly extending in-use position,
a collapsible stairway mounted on the inner frame and movable between a collapsed stored position on the inner frame and an extended in-use position to provide access to said ceiling ope,
actuating means for controlled movement of the stairway between the collapsed stored position and the extended in-use position,
the stairway being a two-part stairway comprising an upper part attached to the inner frame and a lower part attached to the upper part, the two parts of the stairway being hingedly interconnected,
the upper part having an upper end hingedly attached to the inner frame,
the lower part being slidably connected to the inner frame by slide arms which slidably engage complementary slide rails on each side of the lower part of the stairway, said slide arms being pivotally mounted on the inner frame.

In one embodiment of the invention when in the collapsed stored position the stairway locates directly above the inner frame, within a boundary of the inner frame.

Preferably the upper part and lower part of the stairway are hingedly connected at a rear side of the stairway.

In another embodiment the inner frame is pivotally connected at one end by a hinge to the outer frame and a pair of folding support arms interconnect the inner and outer frames at each side spaced apart from the hinge, each support arm being pivotally attached to each frame and being foldable intermediate each end to allow movement of the inner frame between the nested position on the outer frame and the extended in-use position.

In another embodiment stairway bias means is provided for biasing the stairway into the folded stored position on the inner frame and stairway extension means is provided for moving the stairway into the extended position against said bias means.

Conveniently the bias means may comprise one or more gas struts mounted between the stairway and the inner frame.

In another embodiment the stairway extension means comprises a cable extended between the stairway and a cable winding drum and drum motor assembly on the inner frame.

In a further embodiment the actuating means is operable to control operation of said support arms.

In another embodiment the actuating means includes an actuator mounted between the outer frame and a support arm, said actuator having means for pivoting the support arm on the outer frame.

In another embodiment means is provided to counterbalance the weight of the inner frame and stairway. Thus the actuator can readily easily pivot an inner frame on the outer frame.

In another embodiment said counterbalance means comprises a number of gas struts mounted between the outer frame and the support arms.

In one embodiment the upper part and the lower part of the stairway each comprise a pair of parallel spaced-apart stringers interconnected by spaced-apart steps, the depth of each step being greater than the width of the stringers, each step projecting outwardly of the stringers.

In another embodiment the actuating means includes first control means for controlling pivoting of the inner frame on the outer frame and second control means for controlling movement of the stairway between the collapsed position and the extended position.

In a further embodiment the first control means comprises a telescopic actuator mounted between the outer frame and a folding support arm, the telescopic actuator being pivotally mounted on the outer frame and on the support arm, the actuator having a rod which is operable to extend and retract to pivot the arm, the rod being connected to a leadscrew operable by an electric motor to move the rod.

In another embodiment the second control means comprises an electric motor drivably connected to a cable winding drum to which a cable is attached, the cable having a first end attached to the drum and a second end attached to a lower end of the upper stairway part, said second control means further including telescopic struts each having a first end pivotally connected to the inner frame and a second end pivotally connected to the upper stairway part, said struts biasing the upper stairway part towards the folded stored position on the inner frame.

In another embodiment a remote control means is provided for controlling operation of the actuating means.

In a preferred embodiment the actuating means includes a remote controller for remotely operating the folding and unfolding mechanism for the stairway. This may be provided by a portable hand held controller via a radio signal for example, or possibly an operating switch mounted on a wall below the ceiling in which the assembly is mounted and controlling power supply to the folding and unfolding mechanism. Preferably the folding and unfolding mechanism is electrically operated with motors for operating the actuator and the cable winding drum.

### BRIEF DESCRIPTION OF THE DRAWINGS

The invention will be more clearly understood by the following description of some embodiments thereof, given by way of example only, with reference to the accompanying drawings in which;

FIG. 1 is a perspective view of a folding loft stair assembly according to the invention, shown in an extended in-use position;

FIG. 2 is an enlarged detail view showing portion of the assembly;

FIG. 3 is an enlarged detail view showing another portion of the assembly;

FIG. 4 is another perspective view of the assembly, shown in an extended position;

FIG. 5 is an enlarged detail view showing a portion of the assembly;

FIG. 6 is an enlarged detail view showing another portion of the assembly;

FIG. 7 is a perspective view similar to FIG. 4 showing the assembly in a partly folded position;

FIG. 8 is an enlarged detail perspective view showing portion of the assembly of FIG. 7;

FIG. 9 is an enlarged detail perspective view showing another portion of the assembly in FIG. 7;

FIG. 10 is an enlarged side elevational view of the assembly shown in FIG. 7;

FIG. 11 is a front elevational view of the assembly shown in FIG. 7;

FIG. 12 is a perspective view of the assembly, showing the assembly in a fully folded stored position; and

FIG. 13 is an enlarged detail perspective view showing portion of the assembly in FIG. 12.

### DESCRIPTION OF THE PREFERRED EMBODIMENTS

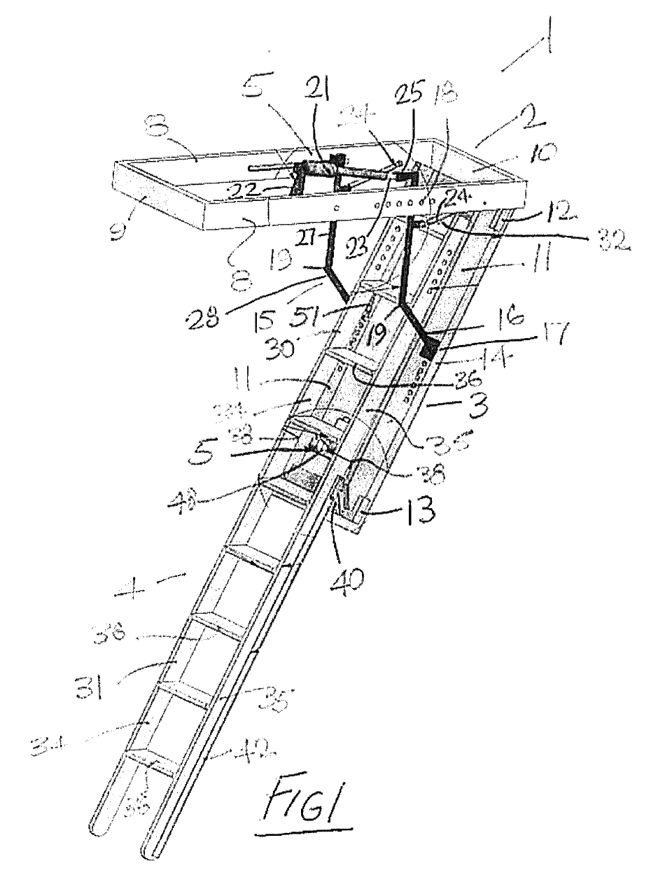

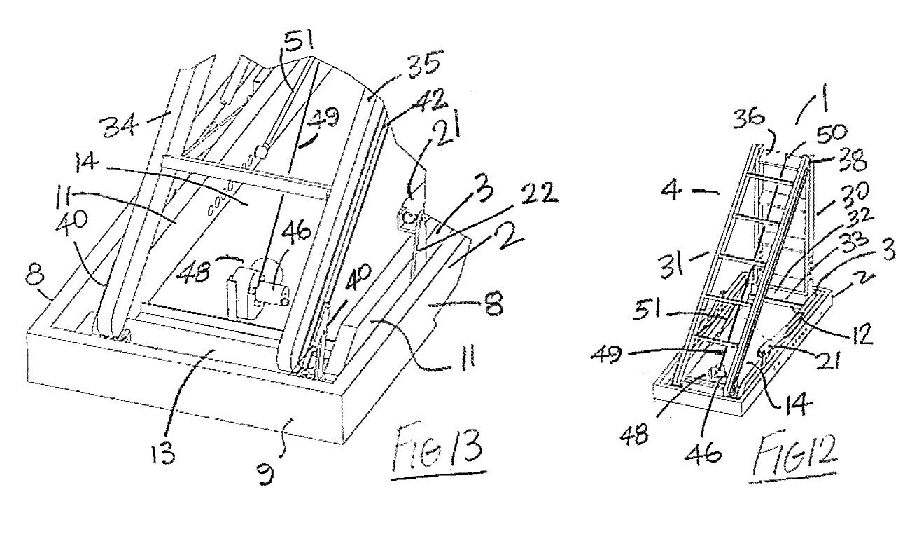

Referring to the drawings, there is illustrated a folding loft stair assembly according to the invention indicated generally by the reference numeral 1. The assembly 1 includes an outer mounting frame 2 of rectangular construction. An associated rectangular inner stairway support frame 3 is pivotally mounted on the outer frame 2 for movement between a nested position within the outer frame 2 as shown in FIG. 12 and a downwardly extending in-use position as shown in FIG. 1. A collapsible stairway indicated generally by the reference numeral 4 is mounted on the inner frame 3 and is movable between a collapsed stored position on the inner frame 3, as shown in FIG. 12, and an extended in-use position, as shown in FIG. 1 to provide access to a ceiling ope communicating with an attic space in a building within which the outer frame 2 is mounted in use. Actuating means, indicated generally at 5 is provided for controlled movement of the inner frame 3 on the outer frame 2 and the stairway 4 on the inner frame 3 between the collapsed stored positions and extended in-use positions. The actuating means 5 can be operated remotely either by a switch or by a hand held controller for example. Thus, the stairway 4 can be extended and collapsed in a controlled and safe manner during use.

The outer mounting frame 2 is of rectangular construction having a pair of spaced-apart side members 8 interconnected at each end by end members 9, 10. The outer frame 10 in use can be secured to rafters or the like in a ceiling ope to securely mount the folding loft stair assembly 1 in the ceiling for access to an attic or the like.

The inner stairway support frame 3 has a pair of spaced-apart parallel side members 11 interconnected by an inner cross member 12 and outer cross member 13 which extend between inner and outer ends respectively of the side members 11. A cover panel 14 is attached to an outer face of the inner support frame 3 to close the ope when the assembly 1 is in the folded stored position shown in FIG. 12.

The inner cross member 12 is hingedly secured to the end member 10 of the outer mounting frame 2 for hinging the inner support frame 3 about a horizontal axis between a lowered inclined position as shown in FIG. 1 and a raised horizontal position as shown in FIG. 12.

A pair of folding support arms 15, 16 interconnect the outer frame 2 and inner frame 3 at each side spaced-apart from the hinge. Each support arm 15, 16 is pivotally attached at its lower end 17 to an outside face of a side member 11 of the inner frame 3 and adjacent its upper end by pivot pin 18 to a side member 8 of the outer frame 2. Each support arm 15, 16 has two parts, namely upper part 27 and lower part 28, which fold each arm 15, 16 intermediate its ends about a hinge 19 to facilitate movement of the inner frame 3 between the nested position and the in-use position.

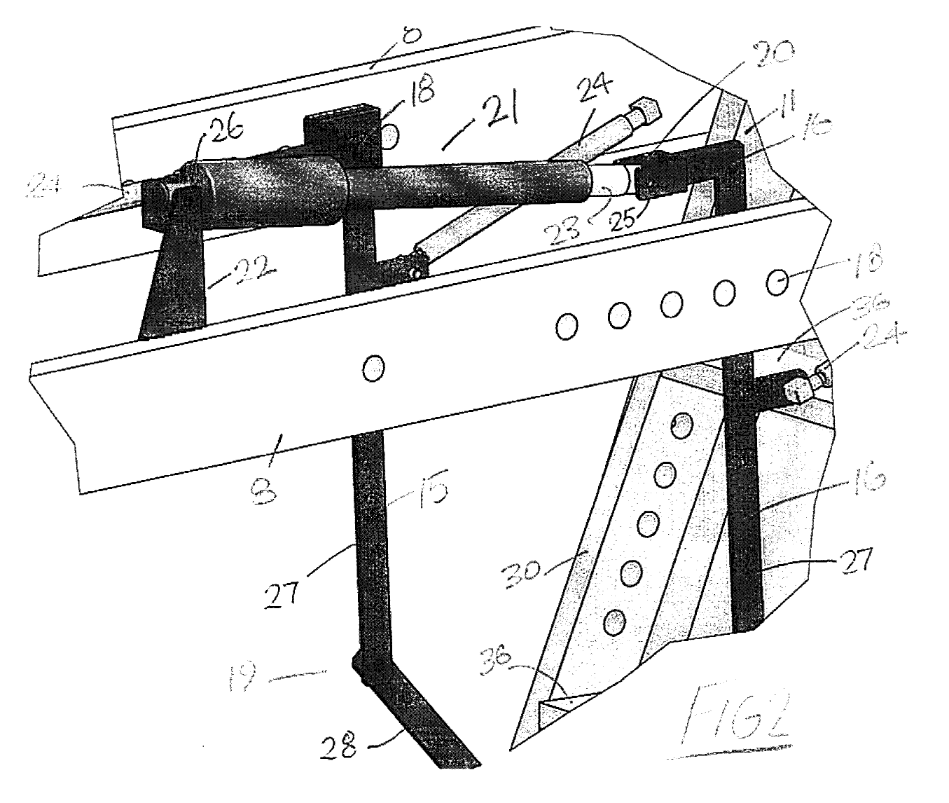

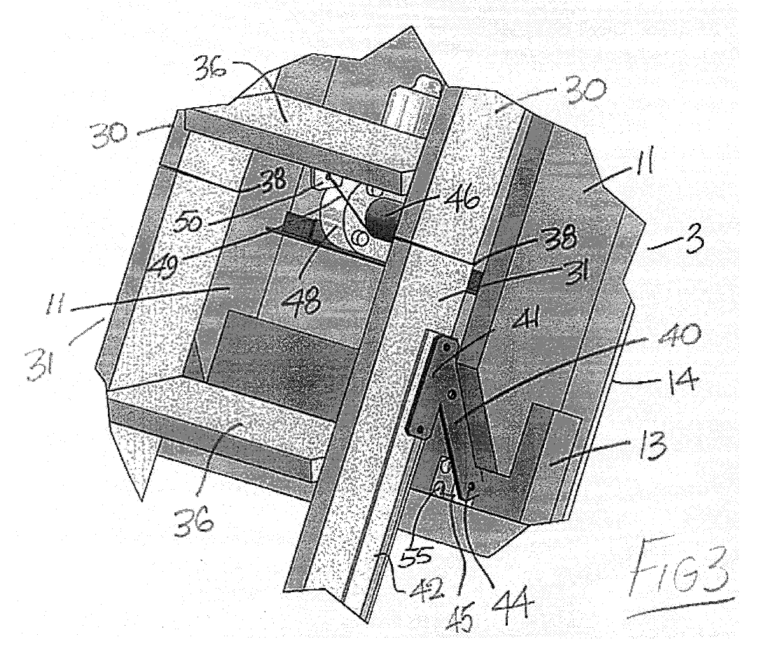

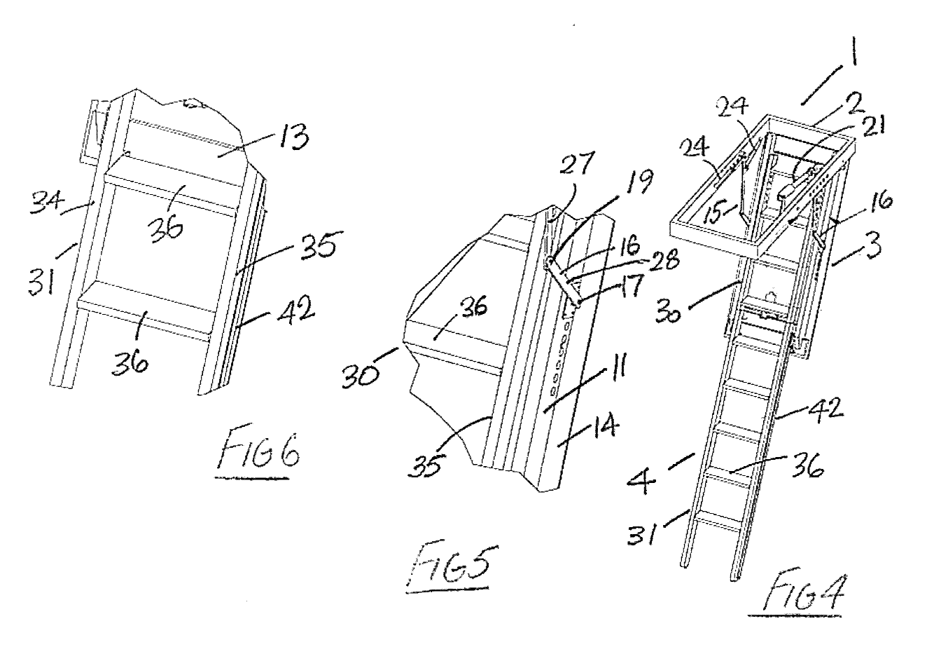

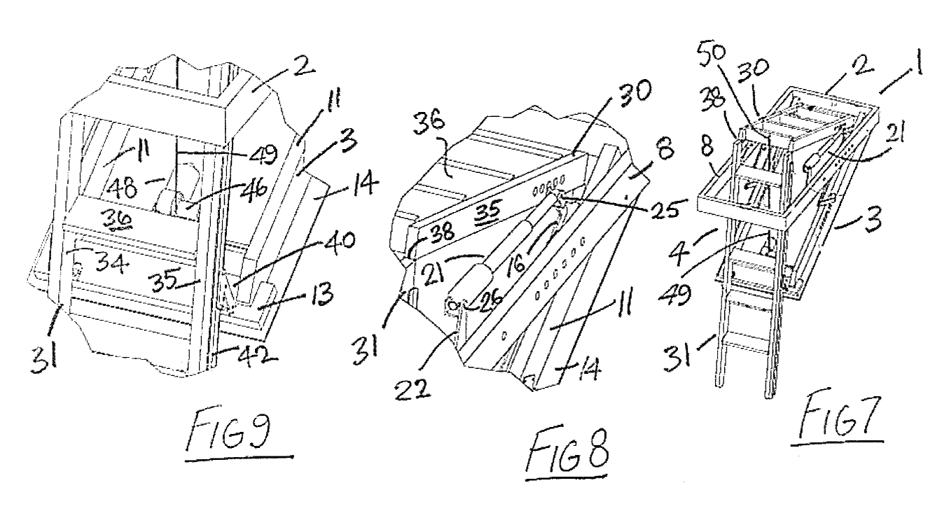

Referring in particular to FIG. 2, a free upper end 20 of one of the arms 16 is pivotally connected at 25 to a telescopic actuator 21 secured by a mounting bracket 22 on the side member 8 of the outer frame 2. An inner end of the telescopic actuator 21 is pivotally connected at 26 to the mounting bracket 22. The actuator 21 has a rod 23 which extends and retracts to pivot the arm 16, and hence both arms 15, 16 together, for raising and lowering the inner frame 3 on the outer frame 2. The rod 23 is connected to a leadscrew operated by an electric motor to move the rod 23. Gas filled struts 24 extend between each arm 15, 16 and an inside face of the adjacent side member 8 of the outer frame 2 to counterbalance the weight of the inner frame 3 and stairway 4 and facilitate smooth movement of the inner frame 3 and stairway 4 between the collapsed and extended positions during deployment and folding of the stairway 4.

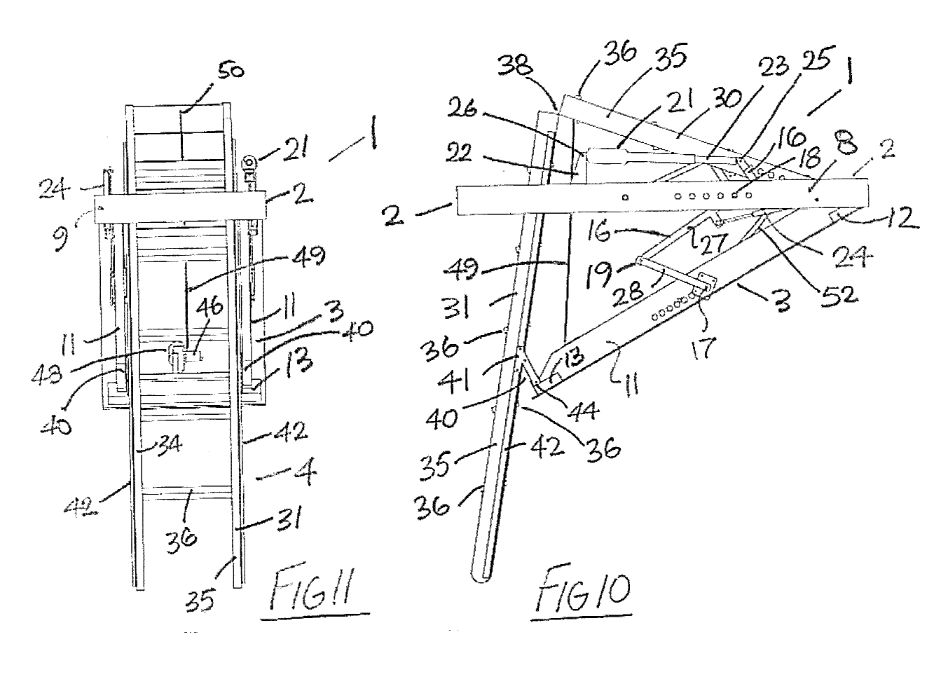

The stairway 4 is in two parts, namely an upper stairway part 30 and a lower stairway part 31. The upper part 30 has at its upper end a cross piece 32 hingedly attached by a hinge 33 to the inner cross member 12 extending between side members 11 of the inner frame 3 for hinging about a horizontal axis. Each part 30, 31 has a pair of parallel spaced-apart side stringers 34, 35 interconnected by spaced-apart steps 36. It will be noted that the steps 36 are relatively deep, for ease of use, comfort and safety, and project outwardly of the side stringers 34, 35 as best seen in FIG. 10. Both stairway parts 30, 31 are interconnected by a hinge 38 on the back edge of the stringers 34, 35 where the two parts 30, 31 meet. Thus, the hinge 38 allows the two stairway parts 30, 31 to pivot relative to each other, as shown in FIGS. 7 and 10, for deployment and folding on the inner frame 3.

The lower stairway part 31 is also slidably connected to the inner frame 3 by a pair of slide arms 40 each having a slide element 41 at an outer end for slidably engaging along a complementary slide rail 42 mounted to an outside face of each stringer 34, 35 of the lower part 31. An inner end of the slide arm 40 is pivotally connected by a pivot pin 44 to a mounting block 45 on the outer cross member 13 of the inner frame 3. In operation the slide arms 40 will pivot on the inner frame 3 about pivot 44 and slide along the rails 42 to allow folding of the two stair parts 30, 31 into an inverted V configuration on the inner frame 3 as shown in FIG. 12.

A geared motor 48 mounted on the inner frame 3 is connected by a cable 49 with the stairway 4 for folding and unfolding the stairway 4 on the inner frame 3 in a controlled manner. The motor 48 operates a cable winding drum 46 to which one end of the cable 49 is attached. The other end of cable 49 connects to an associated eye 50 (best seen in FIG. 3) on an underside of the lowermost step 36 of the stairway upper part 30. A pair of telescopic gas struts 51, 52 connect between an inside face of each side member 11 of the inner frame 3 and the upper part 30 of the stairway 4. Each strut 51, 52 has a first end pivotally connected to the inner frame 3 and a second end pivotally connected to the upper stairway part 30. These struts 51, 52 bias the upper part 30 into the folded stored position shown in FIG. 12. The motor 48 is operable to reel the cable 49 on the drum 46 to pull the upper part 30 against strut bias into the extended in-use position shown in FIG. 1, essentially lying against and along an inside face of the inner stairway support frame 3.

In use, the stairway assembly 1 is mounted in a ceiling ope with the cover panel 14 closing the ope when the assembly 1 is in the folded stored position as shown in FIG. 12. To deploy the stairway 4 for use, a remote control device or wall mounted switch can be operated to cause the actuator 21 to smoothly lower the inner frame 3 on the outer frame 2 and cause the motor 48 and associated cable 49 to extend the stairway 4 to the in-use position shown in FIG. 1. After use, the remote controller or switch is again operated to reverse this process, folding the stairway 4 on the inner frame 3 and pivoting the inner frame 3 upwardly on the outer frame 2 into the closed stored position shown in FIG. 12.

The actuator 21 is operated to pivot the inner frame 3 downwardly on the outer mounting frame. When the inner frame 3 has pivoted downwardly sufficiently, say for example through 15°, a sensor then signals the motor 48 to operate, reeling in the cable 49 and so pulling a lower end of the upper part 30 of the stairway 4 downwardly on the inner frame 3 to extend the stairway 4. In so doing the lower part 31 of the stairway 4 extends outwardly, pivoting about hinge 38 and the rails 42 sliding along the slide arms 40. The stairway 4 will be fully extended before the actuator 21 has fully pivoted the inner frame 3 downwardly and the actuator 21 finally lowers the stairway 4 on to the floor. This process is reversed when folding the stairway 4 on the inner frame 3 and closing the inner frame 3 on the outer frame 2. The actuator 21 starts to raise the inner frame 3. The motor 48 releases tension on the cable 49 allowing it to freely wind out from the drum on which it is wound. The gas struts 51, 52 bias the upper part 30 upwardly folding the stairway 4 on the inner frame 3. The rails 42 on the lower part 31 slide along the slide arms 40 until the stairway 4 is in the fully folded position (FIG. 12). A sensor 55 (FIG. 3) on the outer cross member 13 at a bottom of the upper stairway part 30 registers docking of a lower end of the lower stairway part 31 on the inner stairway support frame 3 in the fully folded position. When the lower part 31 is folded back on to the inner frame 3 within the confines of the inner frame 3 the actuator 21 lifts the inner frame 3 upwardly into the fully closed position within the outer frame 2 as shown in FIG. 12.

It will be appreciated that as the stair assembly is electrically operated the user does not need to manually handle the stairway while it is opening or closing thus removing the danger of physical injury associated with this action. The stairway can not open or close unless a person activates the remote controller or switch which controls operation of the stairway. In the event of power failure the counterbalance gas pistons keep the stairway assembly securely in the closed position. The remote controller may be a radio control unit or may be a fixed switch mounted on a wall adjacent the folding stairway.

Advantageously, the stairway needs no space beyond the trapdoor formed by the inner frame. Because of the stairway design illustrated the stairway stays entirely within the footprint of the inner frame trapdoor when in the closed position. Thus, the stairway assembly can be fitted even where there are restraints beyond the opening.

Further, being a two section stairway and having the folding hinge at the back of the stairs means that the strength of the stairs when in the open position and weight is applied is extremely rigid.

Even with relatively high ceilings there is no difficulty in deploying the stair as it is done entirely automatically. The stairway can also be readily easily deployed by any person, and as no physical intervention is needed to operate the stairway the physical health risk is greatly reduced.

It will also be appreciated that the stairway design of the present invention allows the use of relatively wide steps for greater comfort and safety for persons using the stairway. In a conventional three section stairway the depth of the step is limited as each section has to fold on to the next section and lay flat, thus the depth of the step is determined by the depth of the side stringers. In contrast, with the stairway of the present invention the two stairway parts do not need to fold flat and therefore the depth of the steps can be increased beyond the depth of the side stringers.

The invention is not limited to the embodiments hereinbefore described which may be varied in both construction and detail within the scope of the appended claims.

1. A folding loft stair assembly (1), including:
an outer mounting frame (2) for fixing in an associated ceiling ope,
an inner stairway support frame (3) pivotally mounted on the outer frame (2) for movement between a nested position within the outer frame (2) and a downwardly extending in-use position,
a collapsible stairway (4) mounted on the inner frame (3) and movable between a collapsed stored position on the inner frame (3) and an extended in-use position to provide access to said ceiling ope,
actuating means (5) for controlled movement of the stairway (4) between the collapsed stored position and the extended in-use position,
the stairway (4) being a two-part stairway comprising an upper part (30) attached to the inner frame (3) and a lower part (31) attached to the upper part (30), the two parts (30, 31) of the stairway (4) being hingedly (38) interconnected,
the upper part (30) having an upper end hingedly attached to the inner frame (3),
the lower part (31) being slidably connected to the inner frame (3) by slide arms (40) which slidably engage complementary slide rails (42) on each side of the lower part (31) of the stairway (4), said slide arms (40) being pivotally mounted (44) on the inner frame (3).

2. A folding loft stair assembly (1) as claimed in claim 1, wherein when in the collapsed stored position the stairway (4) locates directly above the inner frame (3), within a boundary of the inner frame (3).

3. A folding loft stair assembly (1) as claimed in claim 1 or claim 2, wherein the inner frame (3) is pivotally connected at one end by a hinge to the outer frame (2) and a pair of folding support arms (15, 16) interconnect the inner (3) and outer (2) frames at each side spaced-apart from the hinge, each support arm (15, 16) being pivotally attached to each frame (2, 3) and being foldable intermediate each end to allow movement of the inner frame (3) between the nested position on the outer frame (2) and the extended in-use position.

4. A folding loft stair assembly (1) as claimed in any preceding claim wherein stairway bias means (51, 52) is provided for biasing the stairway (4) into the folded stored position on the inner frame (3) and stairway extension means (48, 49) is provided for moving the stairway into the extended position against said bias means (51, 52).

5. A folding loft stair assembly (1) as claimed in claim 4, wherein the bias means comprises one or more gas struts (51, 52) mounted between the stairway (4) and the inner frame (3).

6. A folding loft stair assembly (1) as claimed in claim 4 or claim 5, wherein the stairway extension means comprises a cable (49) extended between the stairway (4) and a cable winding drum (46) and drum motor (48) assembly on the inner frame (3).

7. A folding loft stair assembly (1) as claimed in any preceding claim wherein the actuating means (21) is operable to control operation of said support arms (15, 16).

8. A folding loft stair assembly (1) as claimed in any preceding claim, wherein the actuating means includes an actuator (21) mounted between the outer frame (2) and a support arm (15, 16), said actuator (21) having means for pivoting the support arm (15, 16) on the outer frame (2).

9. A folding loft stair assembly (1) as claimed in any preceding claim, wherein means (24) is provided to counterbalance the weight of the inner frame (3) and stairway (4).

10. A folding loft stair assembly (1) as claimed in claim 9, wherein said counterbalance means comprises a number of gas struts (24) mounted between the outer frame (2) and the support arms (15, 16).

11. A folding loft stair assembly (1) as claimed in any preceding claim wherein the upper part (30) and the lower part (31) of the stairway (4) each comprise a pair of parallel spaced-apart stringers (34, 35) interconnected by spaced-apart steps (36), the depth of each step (36) being greater than the width of the stringers (34, 35), each step (36) projecting outwardly of the stringers (34, 35).

12. A folding loft stair assembly (1) as claimed in any preceding claim wherein the actuating means (5) includes first control means (21) for controlling pivoting of the inner frame (3) on the outer frame (2) and second control means (48, 49, 51, 52) for controlling movement of the stairway (4) between the collapsed position and the extended position.

13. A folding loft stair assembly (1) as claimed in claim 12 wherein the first control means comprises a telescopic actuator (21) mounted between the outer frame (2) and a folding support arm (16), the telescopic actuator (21) being pivotally mounted on the outer frame (2) and on the support arm (16), the actuator (21) having a rod (23) which is operable to extend and retract to pivot the arm (16), the rod (23) being connected to a leadscrew operable by an electric motor to move the rod (23).

14. A folding loft stair assembly (1) as claimed in claim 12 or claim 13 wherein the second control means comprises an electric motor (48) drivably connected to a cable winding drum (46) to which a cable (49) is attached, the cable (49) having a first end attached to the drum (46) and a second end attached to a lower end of the upper stairway part (30), said second control means further including telescopic struts (51, 52) each having a first end pivotally connected to the inner frame (3) and a second end pivotally connected to the upper stairway part (30), said struts (51, 52) biasing the upper stairway part (30) towards the folded stored position on the inner frame (3).

15. A folding loft stair assembly (1) as claimed in any preceding claim wherein a remote control means is provided for controlling operation of the actuating means.
